(19) United States
(12) Patent Application Publication
(10) Pub. No.: US 2007/0281749 A1
(43) Pub. Date: Dec. 6, 2007

(54) Electronic Imaging Device

(76) Inventor: Tomoyuki Suga, Kanagawa (JP)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/547,840

(22) PCT Filed: Apr. 5, 2004
(86) PCT No.: PCT/IB04/01411

§ 371 Date: May 10, 2007

(51) Int. Cl. H04B 1/38

(52) U.S. Cl. 455/566

(57) ABSTRACT

An electronic imaging device comprising: a user input unit; a display unit comprising a display, mounted for pivotal movement, relative to the user input unit, about a first fixed axis; and an imaging unit for rotation about a second axis.

### FIELD OF THE INVENTION

Embodiments of the invention relate to an electronic imaging device comprising an imaging unit that rotates about an axis. In particular, some embodiments relate to a multi-mode electronic device that operates as an imaging device and as a hand-portable mobile cellular telephone.

### BACKGROUND TO THE INVENTION

The DoCoMo FOMA P2102V is a flip-style mobile cellular telephone that also operates as an electronic imaging device. It comprises a user input unit; a display unit comprising a display, mounted for pivotal movement, relative to the user input unit, about a first fixed axis; and a fixed imaging unit integrated into the side of the user input unit for capturing video. The display unit comprises a display portion comprising the display and a support portion coupling the display portion to the user input unit. The support portion is mounted for pivotal movement, relative to the user input portion, about the first fixed axis. The display portion is mounted for rotational movement, relative to the support portion, about an axis orthogonal to the first fixed axis. A separate lens cap is provided to protect the fixed imaging unit.

The Samsung SGH-P400 is a flip-style mobile cellular telephone that also operates as an electronic imaging device. It comprises a user input unit; a display unit comprising a display, mounted for pivotal movement, relative to the user input unit, about a the first fixed axis; and an imaging unit for 180 degree rotation about the fixed first axis for taking still pictures. The display unit comprises a display portion comprising the display and a support portion coupling the display portion to the user input unit. The support portion is mounted for pivotal movement, relative to the user input portion, about the first fixed axis. The display portion is mounted for rotational movement, relative to the support portion, about an axis orthogonal to the first fixed axis.

It would be desirable to provide an electronic imaging device that can be used for multiple imaging functions and/or has greater flexibility and convenience of use.

### BRIEF DESCRIPTION OF THE INVENTION

According to one embodiment of the invention there is provided an electronic imaging device comprising: a user input unit; a display unit comprising a display, mounted for pivotal movement, relative to the user input unit, about a first fixed axis; and an imaging unit for rotation about a second axis, substantially perpendicular to the first fixed axis.

According to another embodiment of the invention there is provided an electronic imaging device comprising: a housing; and an imaging unit mounted for rotation relative to the housing, about a fixed axis, by 90 degree increments to one of four mutually orthogonal positions.

According to another embodiment of the invention there is provided an electronic imaging device comprising: a housing; and an imaging unit, comprising a lens aperture, mounted for rotation relative to the housing, about an axis to a stowing position in which the lens aperture faces the housing.

According to another embodiment of the invention there is provided an electronic imaging device comprising: a housing; and an imaging unit, comprising an aperture and an optic and a fixed image sensor, wherein the aperture and optic rotate together, relative to the fixed image sensor, about an axis.

According to another embodiment of the invention there is provided an multi-mode imaging device comprising: a housing having a front face; and an imaging unit having a lens aperture and mounted for rotation relative to the housing, about a fixed axis, wherein the device is operable as a video telephone when the imagining unit is rotated so that the lens aperture captures an image in front of the front face and wherein the device is operable as a camera when the imagining unit is rotated through 180 degrees.

### BRIEF DESCRIPTION OF THE DRAWINGS

For a better understanding of the present invention reference will now be made by way of example only to the accompanying drawings in which:

FIGS. 1 and 2 illustrate a flip-style mobile cellular telephone 10 that operates as an electronic imaging device;

FIGS. 3A and 3B illustrate the electronic imaging device configured as a mobile telephone;

FIG. 4 illustrates the electronic imaging device configured as a video camera;

FIG. 5 illustrates the electronic imaging device configured as a stills camera;

FIG. 6 illustrates the electronic imaging device configured as a video telephone; and

FIG. 7 illustrates the electronic imaging device configured as a tablet computer.

### DETAILED DESCRIPTION OF EMBODIMENTS OF THE INVENTION

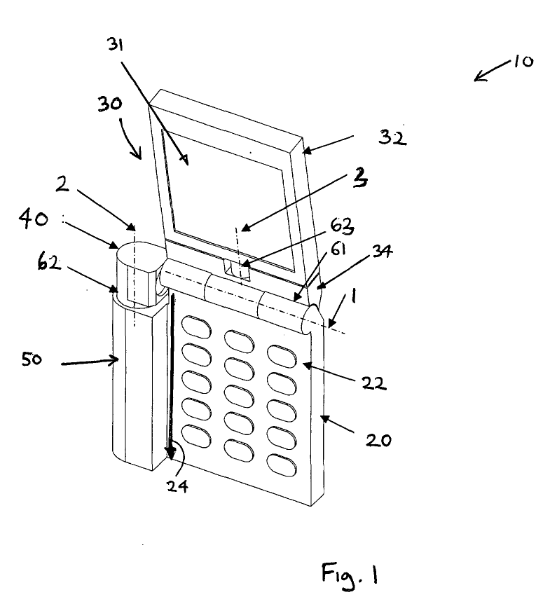

FIG. 1 illustrates a flip-style mobile cellular telephone 10 that operates as an electronic imaging device. The device 10 comprises: a user input unit 20; a display unit 30; an imaging unit 40 and an image sensor housing 50.

The input unit 20 is, in this example, substantially cuboidal. Its extends lengthwise 24, in an orthogonal direction from the first fixed axis 1, from a top edge to termination at a bottom edge. Side edges extend lengthwise between the top and bottom edges. The user input unit 20 comprises a user input device, such as a keypad, which is presented in its front face 22.

The display unit 30 comprises a display 31 and is mounted via hinge 61 for approximately 180 degree pivotal movement, relative to the user input unit 20, about the first fixed axis 1. The display unit 30 comprises a display portion 32 and a support portion 34 that couples the display portion 32 to the user input unit 20. The support portion 34 is mounted via hinge 61 for approximately 180 degree pivotal movement, relative to the user input portion 20, about the first fixed axis 1. The display portion 32, which includes the display 31, is mounted via a swivel 63 for 360 degree rotational movement, relative to the support portion, about a third axis 3 that moves as the support portion 34 rotates.

The imaging unit 40 is mounted via a swivel 62 for 360 degree rotation about a second fixed axis 2 that is orthogonal to the first fixed axis 1. The second fixed axis 2 is substantially parallel to the front face 22 and side edges of the user input unit 20 and passes centrally through the imaging unit. The imaging unit 40 extends, parallel to the second fixed axis 2, adjacent the side edge of the user input unit 20 for at least a portion of the user input unit's length 24.

The image sensor housing 50, in this embodiment is fixed, and connected to the imaging unit 40 via the swivel 62. The image sensor housing 50 extends, parallel to the second fixed axis, adjacent the side edge of the user input unit for at least a portion of the user input unit's length 24. The image sensor housing 50 and the imaging unit 40 together extend along the whole length 24 of the side edge of the user input unit 20, which is longer that the top/bottom edges.

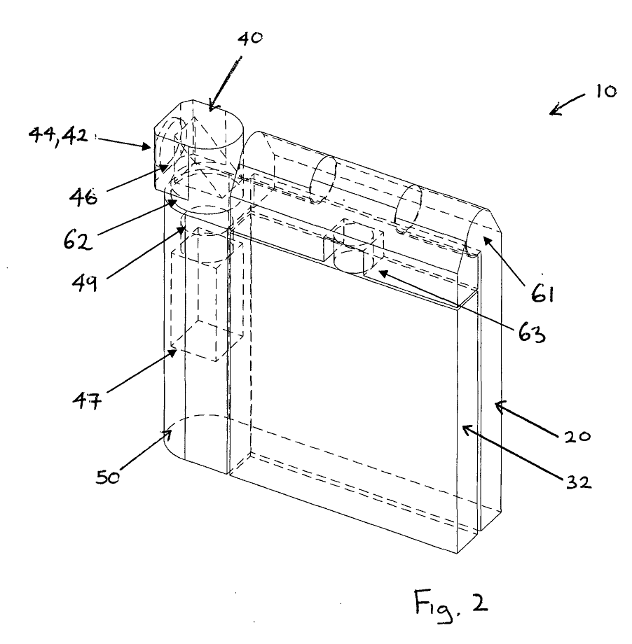

As shown more clearly in FIG. 2, the image sensor housing 50 houses a camera module 47 that comprises one or more image sensors and a lens aperture 49. The camera module 47 is suitable for capturing still and video images and is aligned with the second fixed axis 2. The swivel 62 is provided by a journal comprising an inner and outer tube. One tube is connected to the base of the imaging unit 40 and the other tube is connected to the top of the image sensor housing. As the imaging unit 40 rotates one of the tubes rotates within the other. The lens aperture 49 is aligned with the interior of the inner tube, which provides a light path from the imaging unit 40.

The imaging unit 40 has a single aperture 42 in a sidewall and at least one optic for turning the light that arrives at the aperture 42 through a right-angle and directing it through the lens aperture 49 of the camera module 47. The aperture 42 supports a lens 44 which collects the light and directs to onto a prism (or mirror) 46 which turns the light. When the imaging unit 40 rotates the aperture 42, lens 44 and prism 46 rotate together but the camera module 47 remains stationary.

In a modification to this embodiment, the camera module 47 is integrated into the imaging unit 40. When the imaging unit rotates the aperture 42, lens 44, prism 46 and camera module rotate together. The camera module remains aligned parallel to the second axis 2. This embodiment may improve durability as the alignment of the sensor is independent of the rotation of the imaging unit 40.

In an alternative embodiment, the camera module 47 is integrated into the imaging unit 40 and it is aligned perpendicular to the second axis 2 so that its aperture 49 is aligned with the aperture 42 of the imaging unit. In this embodiment a prism (or mirror) 46 is not required as not light turning is required. When the imaging unit rotates the aperture 42, lens 44, and camera module 47 rotate together. This embodiment has cost and durability advantages.

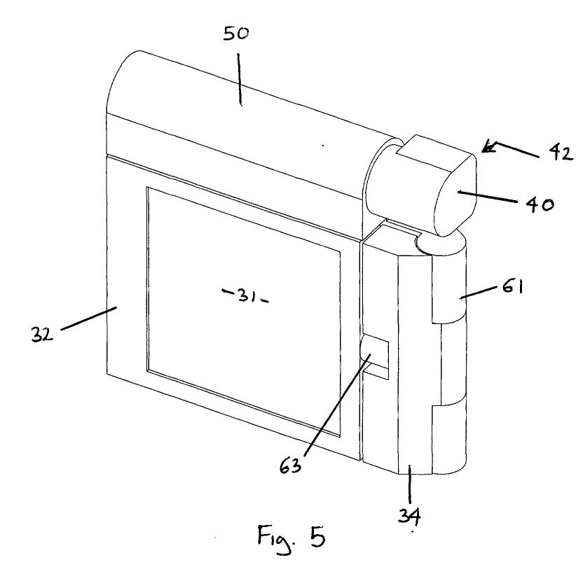

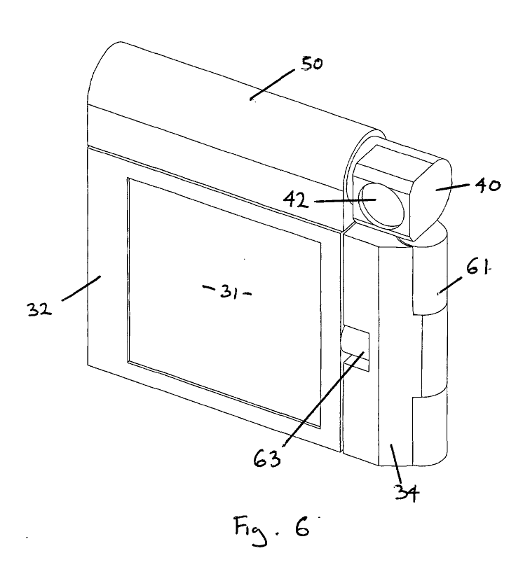

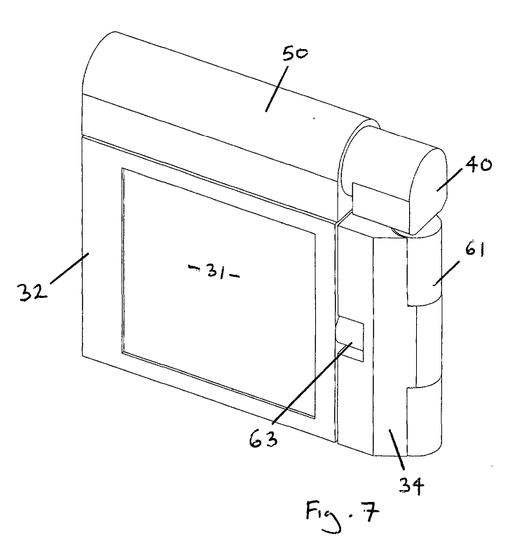

The imaging unit 40 may rotate by 90 degree increments about the second axis 2 to one of four mutually orthogonal positions. The aperture 42 may face towards the hinge 61 (FIG. 1, 3A, 3B, 7), towards the front (FIG. 6.), towards the side (FIG. 2, 4) and towards the rear (FIG. 5). When the aperture 42 faces towards the hinge 61, the imaging unit 40 is stowed. The proximity of the aperture 42 to the hinge 61 protects the lens 44 from damage. In this position the imaging unit 40 is also less susceptible to damage by knocking. A servo motor is used to rotate the imaging unit 40 about the second axis 2.

Preferably, the servo motor is located in the user input unit 20, close to the image sensor housing 50 and just below the imaging unit 40.

The electronic imaging device 10 can operate in a number of different modes and can change between these modes. Each mode uses or may uses a different physical configuration of the device 10.

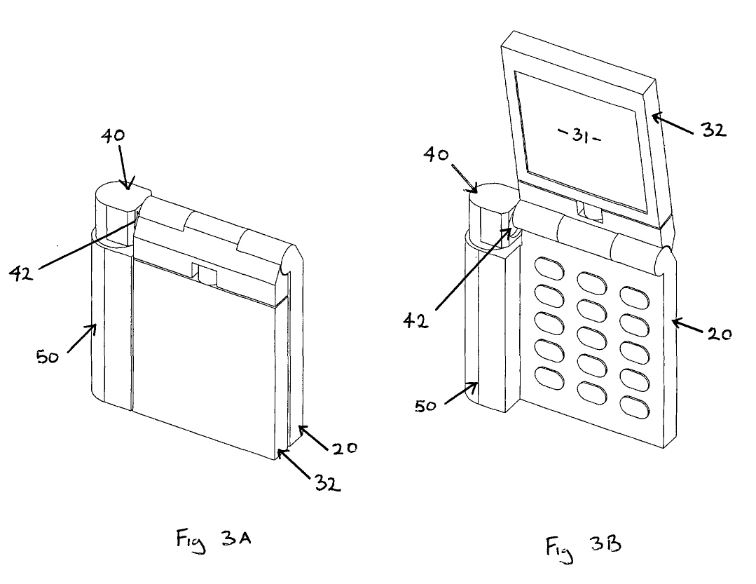

Mobile cellular telephone configurations are illustrated in FIG. 3A and FIG. 3B.

FIG. 3B illustrates an open configuration in which the device 10 is operable as a mobile cellular telephone. All other configurations are described relative to this configuration. In this configuration the imaging unit 40 is stowed at 0 degrees rotation, the display portion 32 is not rotated relative to the support portion 34, and the support portion is at 0 degrees rotation.

FIG. 3A illustrates a closed configuration in which the device is operable as a mobile cellular telephone. The front face 22 of the user input unit 20 is protected by the display unit 30, but the imaging unit 40 is not covered by the display unit 30. In this configuration, the imaging unit 40 is stowed at 0 degrees rotation, the display portion 32 is not rotated relative to the support portion 34 and the support portion 34 is rotated through 180 degrees about the first axis 1.

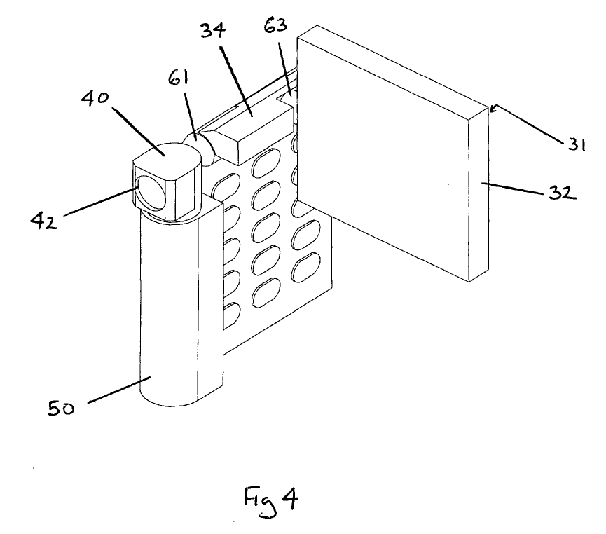

FIG. 4 illustrates a video camera configuration in which the device is operable as a video capture device. In this configuration, the imaging unit 40 is rotated 180 degrees about the second axis 2, the support portion 34 is rotated through 90 degrees about the first axis 1, and the display portion 32 is rotated through 90 degrees about the third axis 3 so that the display 31 and aperture 42 point in opposite directions. The video image displayed in the display 31 is automatically rotated by 90 degrees to correctly orient it.

FIG. 5 illustrates a stills camera configuration in which the device is operable as a stills image capture device. In this configuration, the imaging unit 40 is rotated 90 degrees anti-clockwise about the second axis 2, the support portion 34 is rotated 180 degrees about the first axis 1, and the display portion 32 is rotated through 180 degrees about the third axis 3 so that the display 31 and aperture 42 point in opposite directions. The image displayed in the display 31 is automatically rotated by 90 degrees to correctly orient it.

FIG. 6 illustrates a video telephone configuration in which the device is operable as video telephone or a video conferencing device. In this configuration, the imaging unit 40 is rotated 90 degrees clockwise about the second axis 2, the support portion 34 is rotated 180 degrees about the first axis 1, and the display portion 32 is rotated through 180 degrees about the third axis 3 so that the display 31 and aperture 42 point in the same direction. The image displayed in the display 31 is automatically rotated by 90 degrees to correctly orient it.

FIG. 6 illustrates a tablet personal computer configuration in which the device is operable as tablet device. In this configuration, the imaging unit 40 is stowed, the support portion 34 is rotated 180 degrees about the first axis 1, and the display portion 32 is rotated through 180 degrees about the third axis 3. The image displayed in the display 31 is automatically rotated by 90 degrees to correctly orient it.

| | | support | display | |
|---|---|---|---|---|
| Configuration | imaging unit | portion | portion | Fig |
| phone | 0 | 0 | 0 | 3B |
| video | 180 | 90 | 270 | 4 |
| camera | | | | |
| stills camera | 270 | 180 | 180 | 5 |
| video phone | 90 | 180 | 180 | 6 |
| tablet | 0 | 180 | 180 | 7 |

Although embodiments of the present invention have been described in the preceding paragraphs with reference to various examples, it should be appreciated that modifications to the examples given can be made without departing from the scope of the invention as claimed.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.”

1. An apparatus comprising:
a user input unit;
a display unit comprising a display, mounted for pivotal movement, relative to the user input unit, about a first fixed axis; and
an imaging unit for rotation about a second axis, substantially perpendicular to the first fixed axis.

2. The apparatus as claimed in claim 1 wherein the imaging unit is mounted for substantially 360 degree rotation about the second axis.

3. The apparatus as claimed in claim 1, wherein the display unit comprises a display portion comprising the display and a support portion coupling the display portion to the user input unit, and wherein the support portion is mounted for pivotal movement, relative to the user input portion, about the first fixed axis and the display portion is mounted for rotational movement, relative to the support portion, about a third axis.

4. The apparatus as claimed in claim 3, wherein the support portion is mounted for substantially 180 degree rotation about the first fixed axis.

5. The apparatus as claimed in claim 3 wherein the display portion is mounted for substantially 360 degree rotation about the third axis.

6. An electronic device The apparatus as claimed in claim 1, wherein the user input unit comprises a front face and the second fixed axis is substantially parallel to the front face.

7. The apparatus as claimed in claim 1, wherein the imaging unit is mounted for rotation, about the second axis, by 90 degree increments to one of four mutually orthogonal positions.

8. The apparatus as claimed in claim 1, wherein the imaging unit, comprises an aperture, and is mounted for rotation about the second axis to a stowing position in which the aperture faces and is adjacent the user input unit.

9. The apparatus as claimed in claim 1, further comprising a fixed image sensor, wherein the imaging unit, comprises an aperture and an optic, that rotate together about the second axis.

10. The apparatus as claimed in claim 9, wherein the image sensor is at an orthogonal orientation to the aperture and the optic includes a mirror or prism for directing light from the aperture to the image sensor.

11. The apparatus as claimed in claim 1, wherein the imaging unit, comprises an aperture, an optic and an image sensor, wherein the aperture, optic and image sensor are mounted for rotation together about the second axis.

12. The apparatus as claimed in claim 11, wherein the image sensor is at an orthogonal orientation to the aperture and the optic includes a mirror or prism for directing light from the aperture to the image sensor.

13. The apparatus as claimed in claim 11, wherein the image sensor is aligned with the aperture and the optic includes a lens for directing light from the aperture to the image sensor.

14. The apparatus as claimed in claim 1, wherein the user input unit extends lengthwise in an orthogonal direction from the first fixed axis and the imaging unit extends adjacent the user input unit for at least a portion of its length.

15. The apparatus as claimed in claim 1, wherein the apparatus is operable as a video telephone and as a camera and wherein the imagining unit is rotated through 180 degrees when the operation of the apparatus switches from a video telephone to a camera.

16. The apparatus as claimed in claim 3, wherein the apparatus is operable as a telephone and as a video camera and wherein, when the operation of the device apparatus is switched from a telephone to a video camera, the imaging unit is rotated through 180 degrees, the support portion is rotated anti-clockwise through 90 degrees, and the display portion is rotated clockwise through 270 degrees.

17. The apparatus as claimed in claim 3, wherein the apparatus is operable as a telephone and as a video telephone and wherein, when the operation of the apparatus is switched from a telephone to a video telephone, the imaging unit is rotated clockwise through 90 degrees, the display portion is rotated through 180 degrees and the support portion is rotated through 180 degrees.

18. The apparatus as claimed in claim 3, wherein the apparatus is operable as a telephone and as a still camera and wherein, when the operation of the apparatus is switched from a telephone to a still camera, the imaging unit is rotated anti-clockwise through 90 degrees, the display portion is rotated through 180 degrees and the support portion is rotated through 180 degrees.

19. The apparatus as claimed in claim 1, having one or more of the configurations specified in Table 1.

20. The apparatus as claimed in claim 1, operable as a mobile cellular telephone.

21. An electronic imaging device comprising:
a housing; and
an imaging unit mounted for rotation relative to the housing, about a fixed axis, by 90 degree increments to one of four mutually orthogonal positions.

22. An electronic imaging device comprising:
a housing; and
an imaging unit, comprising a lens aperture, mounted for rotation relative to the housing, about an axis to a stowing position in which the lens aperture faces the housing.

23. The electronic device as claimed in claim 22, wherein the user input unit extends lengthwise in an orthogonal direction from the first fixed axis, and the imaging unit extends adjacent the user input unit for at least a portion of its length, wherein the display unit pivots about the first axis to cover a front face of the user input unit but not the imaging unit.

24. An electronic imaging device comprising:
a housing; and
an imaging unit, comprising an aperture and an optic and a fixed image sensor, wherein the aperture and optic rotate together, relative to the fixed image sensor, about an axis.

25. The electronic device as claimed in claim 24, wherein the image sensor is at an orthogonal orientation to the aperture and the optic includes a mirror or prism for directing light from the aperture to the image sensor.

26. An multi-mode imaging device comprising:
a housing having a front face; and
an imaging unit having a lens aperture and mounted for rotation relative to the housing, about a fixed axis, wherein the device is operable as a video telephone when the imagining unit is rotated so that the lens aperture captures an image in front of the front face and wherein the device is operable as a camera when the imagining unit is rotated through 180 degrees.

27. An electronic imaging device comprising: a user input unit; a display unit
comprising a display, mounted for pivotal movement, relative to the user input unit, about a first fixed axis; and an imaging unit for rotation about a second axis.

28. (canceled)

29. (canceled)

30. The apparatus as claimed in claim 1, further comprising a motor for rotating the imaging unit.
